(19) United States
(12) Patent Application Publication
(10) Pub. No.: US 2025/0250711 A1
(43) Pub. Date: Aug. 7, 2025

(54) METAL PLATING OF GASLINE INTERIOR SURFACES

(71) Applicant: Applied Materials, Inc., Santa Clara, CA (US)

(72) Inventor: Joseph Frederick Behnke, San Jose, CA (US)

(21) Appl. No.: 18/434,699

(22) Filed: Feb. 6, 2024

(51) Int. Cl. C25D 7/04; C23C 18/16; C23C 18/32; C23C 28/02; C25D 17/12; F16L 58/08

(52) U.S. Cl. CPC C25D 7/04; C23C 18/1653; C23C 18/32; C23C 28/023; C25D 17/12; F16L 58/08

(57) ABSTRACT

Embodiments of the disclosure relate to a method that includes threading an anode wire though a metal conduit. The anode wire includes a dielectric layer that is permeable to metal ions and prevents the anode wire from establishing a short with the metal conduit. The method further includes filling the metal conduit with an electrolyte solution and applying an electrical bias between the anode wire and the metal conduit to cause the metal ions from the electrolyte solution to propagate to the metal conduit and form a metal layer on an internal surface of the metal conduit.

### TECHNICAL FIELD

Embodiments of the present disclosure relate to methods for depositing metal coatings on the interior surface of metal conduits. More specifically, it relates to electroless and electrolytic methods of forming protective metal coatings on the interiors of gaslines.

### BACKGROUND

Nickel coatings are beneficial for protection against corrosion for stainless-steel components. It is beneficial to reduce the rate of corrosion of stainless-steel components with stable, non-reactive materials (e.g. Nickel) to limit the degradation of components and the release of contaminants in the fluid contacted by the components. Conventional methods of depositing Nickel coatings on stainless-steel components fail to achieve Nickel metal layers inside the inner volumes of conduits.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one aspect of the present disclosure, a method includes threading an anode wire through a metal conduit. The anode wire includes a dielectric layer that is permeable to metal ions. The dielectric layer prevents the anode wire from establishing a short with the metal conduit. The method further includes filling the metal conduit with an electrolytic solution. The method further includes applying an electrical bias between the anode wire and the metal conduit to cause the metal ions from the electrolytic solution to propagate to the metal conduit and form a metal layer on an internal surface of the metal conduit.

In one aspect of the present disclosure, an apparatus includes a fluid basin configured to retain an electrolytic solution to be used to coat an interior surface of a metal conduit with a metal layer. The apparatus further includes an anode wire to be threaded through the metal conduit. The anode wire includes a dielectric layer that is permeable to metal ions. The dielectric layer prevents the anode wire from establishing a short with the metal conduit. The apparatus further includes an electrical source to apply an electrical bias between the anode wire and the metal conduit while the electrolytic solution is within the metal conduit and form the metal layer on the internal surface of the metal conduit.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A illustrates a schematic sectional view of an electrochemical plating cell having an anode threaded through a metal conduit in a basin of plating solution according to aspects of the present disclosure.

FIG. 1B illustrates a schematic sectional view of an electrochemical plating apparatus having an anode threaded through a metal conduit with plating solution pumped into the interior volume of the metal conduit according to aspects of the present disclosure.

FIG. 2 illustrates an anode wire that includes a dielectric layer that further includes a polymeric electrolyte sheath according to aspects of the present disclosure.

FIG. 3A illustrates a cross-sectional view of a coated metal conduit according to aspects of the present disclosure.

FIG. 3B illustrates a cross-sectional view of a coated metal conduit according to aspects of the present disclosure.

FIG. 4A illustrates a cross-sectional view of an anode threaded through a metal conduit with plating solution occupying volume between the anode, the electrolytic sheath, and the metal conduit, according to aspects of the present disclosure.

FIG. 4B illustrates a schematic sectional view of an anode threaded through a metal conduit with plating solution occupying volume between the anode, the electrolytic sheath, and the metal conduit, according to aspects of the present disclosure.

FIG. 5 is a flow chart for a method of depositing a metal layer on the internal surface of a metal conduit, according to embodiments of the present disclosure.

FIG. 6 is a flow chart for a method of performing electroless plating on the metal layers of the internal surface of a metal conduit, according to embodiments of the present disclosure.

### DETAILED DESCRIPTION

Exposure to corrosive materials can degrade uncoated stainless-steel components resulting in frequent replacement and the risk of contamination of fluids contacted by corroded or damaged components. Metal coatings such as nickel coatings (e.g., a nickel plating) are beneficial in reducing the rate of corrosion of stainless-steel components with a stable, nonreactive material to limit the degradation of materials. Conventional methods of depositing protective metal coatings on surfaces of metal components using far field electrodes fail to effectively and uniformly coat the central internal surfaces of a metal conduit. It is particularly difficult to apply metal coatings on the interior of conduits. This limits the length of metal conduit that can have effective coatings created by conventional methods, and prevents the use of self-propagating deposition methods to build upon metal seed layers. Conventional metal coating or plating is capable of plating the outer side of conduits, but is generally incapable of adequately plating the interior of such conduits.

In an example, an electrolytic deposition process uses an anode in close proximity to a surface that is to receive a metal coating. To coat the interior of a metal conduit, the anode may be threaded through an interior of the metal conduit. However, if a bare wire is used for the anode, the wire is prone to make contact with the interior surface of the metal conduit, which causes a short and prevents electrochemical deposition. This problem may occur in particular for long sections of conduit and/or for conduit that is not straight.

Moreover, when far field electrodes (electrodes placed outside of the interior of a metal conduit) are used for the deposition of a seed layer of a metal onto a conduit, the deposition of material preferentially occurs on the interior and exterior surfaces that are nearest to the openings of the metal conduit that have more direct access to the electrode. This leaves the central interior surface area of the conduit without the deposition of the seed layer, or results in non-uniform deposition of seed layers throughout the conduit. Without the accurate deposition of a thin seed layer of the metal, additional self-propagating deposition methods are unable to be used to achieve coatings of effective thickness. Not only does this limit the length of metal conduit that can be coated, but also results in coatings being applied to the outer walls of the metal conduit, where they may not provide a benefit. Breaking metal conduits into shorter pieces also results in creating additional interfaces that use fittings to connect into longer pipeline sections, creating weak points for potential leaks in a system.

Embodiments of the present disclosure relate to a method and apparatus for depositing protective metal coatings on the internal surface of metal conduits (e.g. gasline pipes). In embodiments, an anode wire is threaded through the internal volume of a metal conduit. By threading the anode wire through the interior of the conduit, the anode wire is placed in close proximity to the interior walls of the conduit. The anode wire may then be used to generate a strike. The anode wire includes a dielectric layer that is permeable to the metal ions that make up a corresponding plating solution. While the dielectric layer allows for the metal ions access to the anode wire it also prevents the anode wire from making contact with the internal surface of the metal conduit and a causing a short. The dielectric layer may be or include a polymeric electrolyte sheath. In some embodiments, the dielectric layer may be or include a porous coating.

The coated anode may be used for form a strike on the interior surface of a metal conduit to be coated. A strike is an optional preliminary electroplating step that forms a thin but highly adherent layer on a surface. A strike may be run at lower metal concentrations, at higher current densities, and/or with few or no special additives. In embodiments, a seed layer or strike of a metal such as Nickel may be deposited onto the internal surface of the metal conduit via a strike process, such as the Wood's Nickel strike process. This initial seed layer or strike of the metal (e.g., Nickel) provides the basis for additional metal layer deposition via various subsequent deposition processes such as electrolysis or electroless plating. In embodiments, the anode wire may be removed from the metal conduit after the strike is formed. A further electrolysis or electroless plating process may then be formed to form a thicker metal coating or plating (e.g., of Nickel) over the strike. This further electroless plating process may be performed without the anode, and optionally with a different electrolytic solution.

In embodiments, the metal conduit may be rinsed after the removal of the anode wire and then may be rinsed to remove any residual plating solution from the surface of the metal conduit. The metal conduit may then be placed into an electroless plating bath. In some embodiments, electroless plating may be performed to form one or more additional layers over the metal layer to form a thicker metal coating (e.g., Nickel plating).

In some embodiments, the metal conduit may include a curved portion. In some embodiments, a basin may be configured to retain the shape of the metal conduit. In some embodiments, the metal conduit may be configured to retain the plating solution in the interior volume of the metal conduit. In some embodiments, the conduit may be coupled to a plating system that pumps plating solution through the interior of the conduit for plating. In some embodiments, the plating system may cycle plating solution through the interior volume of the metal conduit during formation of the strike and/or of the further layers of the metal coating on the interior surface of the conduit. This allows a metal conduit of any length or shape to have a protective metal layer deposited on the interior surface of the metal conduit. The plating system may include a basin or storage unit that contains the plating solution, a fluid delivery line that connects the basin or storage unit to a first end of the conduit, an additional fluid line that connects the basin or storage unit (or alternatively an abatement or disposal system) to a second end of the conduit, and a pump that causes the plating solution to pump through the interior of the conduit during plating.

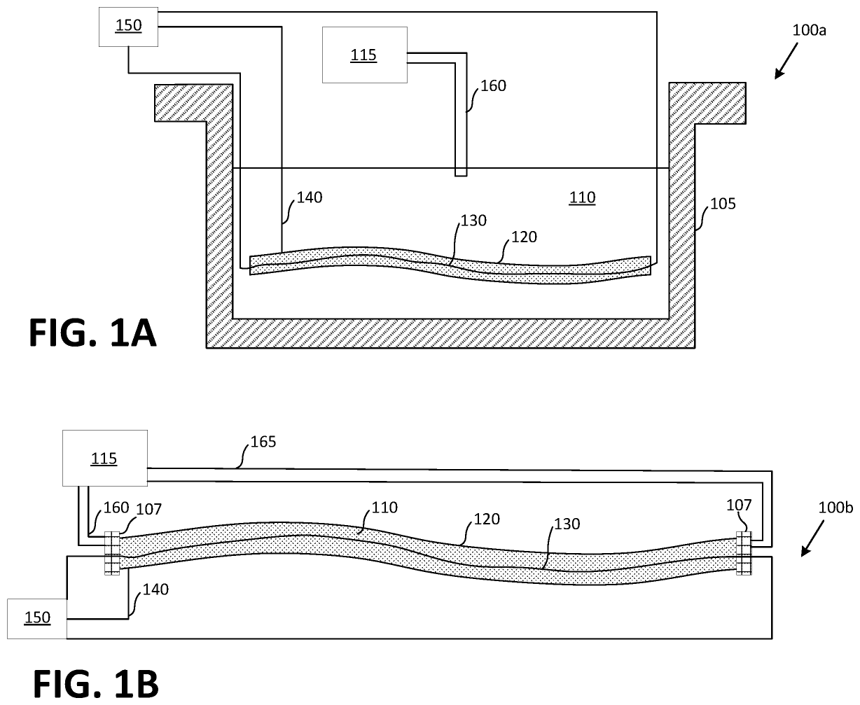

FIG. 1A illustrates a schematic sectional view of an electrochemical plating cell 100a. The electrochemical plating cell 100a may include a basin 105 that is configured to contain a metal conduit 120. The basin 105 may be further configured to retain a plating solution in a fluid volume 110. A plating solution supply 115 may be configured to provide plating solution to the fluid volume 110. In some embodiments, the plating solution supply 115 may provide plating solution via a circulation line 160.

The plating solution may be an electrolyte solution. The electrolyte solution may be any electrolyte solution known in the art. An example of a plating solution used for Nickel plating may include Nickel Sulfate (NiSO4), Nickel Chloride (NiCl2), Boric Acid (H3BO3), one or more wetting agents, one or more brighteners, and/or one or more additives. Nickel Sulfate may be used as a primary source of nickel ions in the electrolyte solution. Nickel Sulfate provides nickel cations (Ni²⁺) used for the electroplating process. Nickel sulfate hexahydrate (NiSO4·6H2O) may be used, for example. Nickel chloride may be added to the solution to increase the solubility of nickel ions and improve a conductivity of the bath. It can help to maintain a stable and consistent plating process. Boric acid may be used as a buffer in the solution to maintain the pH level of the bath. Controlling the pH can help for achieving a uniform and high-quality nickel deposit. Wetting agents or surfactants may be added to the solution to improve the wetting of the substrate surface. This can help to ensure an even and smooth nickel plating. Depending on the specific application and target finish, various brighteners and/or additives may be included in the nickel plating bath. These additives can influence the appearance, brightness, and leveling of the nickel deposit. The exact composition and concentration of the chemicals in the electrolyte solution may vary depending on the target properties of the metal plating, such as substrate material that the coating will be formed on, target thickness of the metal coating, and so on.

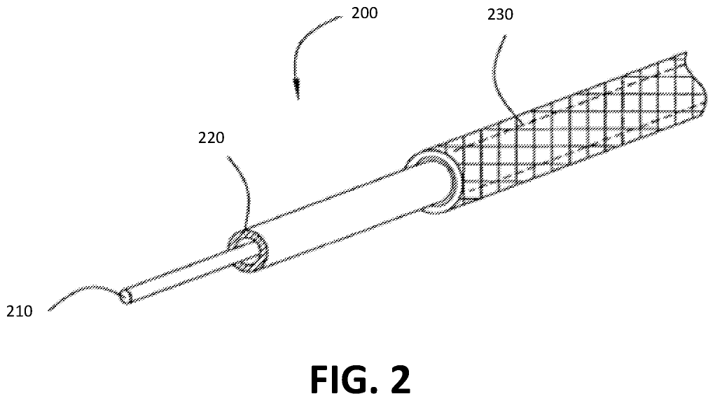

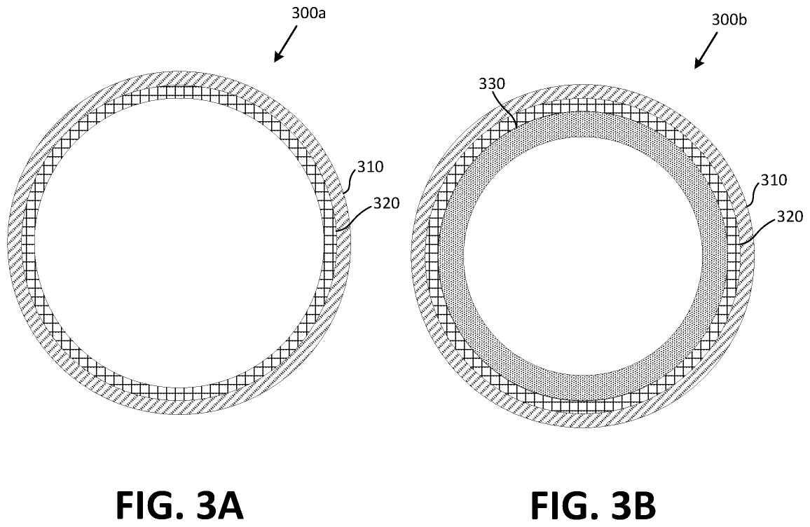

In embodiments, an anode wire 130 is threaded through the metal conduit 120 to so as to place the anode wire in close proximity to the interior surface of the metal conduit 120. In embodiments, the anode wire 120 includes a dielectric layer (not pictured in the figure) that is permeable to metal ions. In embodiments, the dielectric layer prevents the anode wire 130 from establishing a short with the metal conduit 120. In some embodiments the dielectric layer includes a polymeric electrolyte sheath, which is described in greater detail below with reference to FIGS. 2-3B.

In some embodiments, a power supply 150 is coupled between the anode wire 130 and the metal conduit 120. In some embodiments, the metal conduit 120 is coupled to the power supply 150 via a contact 140. In some embodiments, the power supply 150 provides a plating bias to the metal conduit 120 during the plating process.

In some embodiments, the power supply 150 is coupled to between the anode wire 130 and the metal conduit 120 in a complete electrical circuit. In some embodiments, the electrochemical plating apparatus may include an auxiliary power supply (not pictured).

The interior surface of the metal conduit may first be cleaned prior to the plating process to remove any contaminants, oils and/or oxides. The electrolytic solution (plating solution) that contains metal ions (e.g., nickel, copper, gold, etc. ions) in the form of a metal salt may then be introduced into the interior of the metal conduit after the anode has been threaded through the interior of the metal conduit. The metal conduit may serve as the cathode and the wire threaded through the interior of the metal conduit may serve as the anode. When an electric current is applied, metal ions of the electrolyte solution are reduced at the cathode (e.g., the interior walls of the metal conduit) and are deposited on its surface. Meanwhile, metal atoms from the anode may dissolve into the electrolyte to maintain the metal ion concentration. Metal ions are attracted to the cathode (walls of the metal conduit) due to the electric field created by the external current provided by the power supply. These metal ions adhere to the inner walls of the metal conduit and form a layer (e.g., a strike) of plated metal.

Plating with good adhesion onto stainless steel is difficult because a passive oxide layer may form on the stainless steel body.—and you want to plate onto metals, not onto oxides. Very acidic but somewhat dilute nickel plating solutions called “Wood's Nickel Strike” or “Sulphamate Nickel Strike” can simultaneously dissolve the passive layer and deposit a fresh but thin nickel layer on it, which allows subsequent electroplating with nickel or other metals

In some embodiments, the metal conduit 120 may include a gasline pipe. In some embodiments, the metal conduit 120 may be curved.

In some embodiments, the metal conduit 120 may be formed from stainless-steel. In some embodiments, the metal conduit 120 may be formed from aluminum. Alternatively, the metal conduit may be formed from some other metal. Examples of metal alloys that may be used for the metal conduit include austenitic stainless steel, ferritic stainless steel, martensitic stainless steel, 1000 series aluminum alloy, 2000 series aluminum alloy, 3000 series aluminum alloy, 5000 series aluminum alloy, 6000 series aluminum alloy, 7000 series aluminum alloy, and so on.

In some embodiments, an entirety of the metal coating may be formed via electrolytic plating. Alternatively, in some embodiments a thin initial layer (e.g., a strike) may be formed via electrolytic plating. Subsequently, the anode may be removed, the metal conduit may be rinsed, and an electroless plating process may be performed to form one or more additional layers of the metal coating over the initial thin layer (e.g., over the strike). In embodiments, an autocatalytic process is performed where metal ions in a plating solution (which may be different from the plating solution used to perform the electrolytic plating) are reduced by a reducing agent in the plating solution and are attracted to catalytic sites on the inner walls of the metal conduit (e.g., to the strike that was formed on the inner walls of the metal conduit). This reduction process may be self-sustaining. As more metal is deposited onto the inner walls of the metal conduit, further reduction of metal ions may be catalyzed. The electroless plating process may be performed until a target coating thickness is achieved.

FIG. 1B illustrates a schematic sectional view of an electrochemical plating apparatus 100b. The electrochemical plating apparatus 100b may include seals 107 at either end of the metal conduit 120 that allow for the retention of a fluid volume 110 of plating solution in the interior volume of the metal conduit 120. In some embodiments, the seals 107 at either end of the metal conduit 120 may be configured to allow for an anode wire 130 to be threaded through the interior volume of the metal conduit 120.

In some embodiments, the seals 107 may be further configured to provide access to a circulation line 160 and recirculation line 165 to the interior volume of the metal conduit 120. A plating solution supply 115 may be configured to provide plating solution to the fluid volume 110.

In some embodiments, the plating solution supply 115 may provide plating solution via a circulation line 160. In some embodiments, the fluid volume 110 may be recirculated through the interior volume of the metal conduit 120 via a recirculation line 165. In some embodiments the plating solution supply 115 prevents the depletion of metal ions in the fluid volume 110 by the plating process.

An anode wire 130 is threaded through the metal conduit 120 to allow access to the interior surface of the metal conduit 120. In embodiments, the anode wire 120 includes a dielectric layer (not pictured in the figure) that is permeable to metal ions. In embodiments, the dielectric layer prevents the anode wire 130 from establishing a short with the metal conduit 120. In some embodiments the dielectric layer includes a polymeric electrolyte sheath.

In some embodiments, a power supply 150 is coupled between the anode wire 130 and the metal conduit 120. In some embodiments, the metal conduit 120 is coupled to the power supply 150 via a contact 140. In some embodiments, the power supply 150 provides a plating bias to the metal conduit 120 during the plating process.

In some embodiments, the power supply 150 is coupled to between the anode wire 130 and the metal conduit 120 in a complete electrical circuit. In some embodiments, the electrochemical plating apparatus may include an auxiliary power supply (not pictured). In embodiments, an electrolytic deposition process may be performed using electrochemical plating apparatus 100b as described with reference to FIG. 1A. For example, the electrolytic deposition process may be performed to form a strike on the metal conduit. Subsequently, the anode wire 130 may be removed from the interior of the metal conduit 120, and an electroless plating process may be performed using the electrochemical plating apparatus 100b. For the electroless plating process, a different plating solution may be used than is used for the electrolytic plating. Alternatively, a different electrochemical plating apparatus may be used to perform the electroless plating process, which may be of the type described with reference to FIG. 1A or of the type described with reference to FIG. 1B (except for the absence of the anode wire 130).

FIG. 2 illustrates an anode wire 200 that includes a dielectric layer 220 that is or includes a polymeric electrolyte sheath 230 according to aspects of the present disclosure. The anode wire 200 includes an auxiliary electrode 210 encased in a dielectric layer 220 which is further encased in a polymeric electrolyte sheath 230 in an embodiment.

In some embodiments, the electrolyte sheath 230 may be made from an inert plastic material, such as natural polypropylene, polyvinylidene fluoride (PVDF), or TELFON®. In some embodiments, the polymeric electrolyte sheath 230 is formed from Nafion®. In some embodiments, the electrolyte sheath 230 may provide mechanical strength to the dielectric layer 220. In some embodiments, the dielectric layer 220 and the electrolyte sheath 230 may be laminate layers on the auxiliary electrode 210. In some embodiments, the dielectric layer 220 and electrolyte sheath 230 may be independent layers and may be unattached to the either each other or the auxiliary electrode 210. In some embodiments, the dielectric layer 220, the electrolyte sheath 230 and the auxiliary electrode 210 layers are anchored to one another with interspersed spokes (not pictured).

In some embodiments, the auxiliary electrode 210 may formed from platinum. In some embodiments, the auxiliary electrode 210 may be formed from nickel or any other metal suitable for use as either a soluble or insoluble electrode for electrochemical plating. In some embodiments, the auxiliary electrode 210 may be manufactured from a core material, such as stainless-steel, titanium, or other suitable metal. In some embodiments, the auxiliary electrode 210 may include an interior metal selected from the previously listed metals and a different exterior metal coated on the surface. In some embodiments, the auxiliary electrode 210 may have a wire, ring, or toroid shape. In some embodiments, the auxiliary electrode may have a shape configured to the shape of the metal conduit. In some embodiments, the auxiliary electrode 210 may be a single continuous wire. In some embodiments, the auxiliary electrode 210 may have multiple strands extending from branched points.

In some embodiments, the dielectric layer 220 includes a porous material. In some embodiments, the porous material may include Durapore Hydrophilic porous Membrane. In some embodiments, the porous material may include porous glass, porous ceramics, silica aerogels, organic aerogels, porous polymeric materials, and/or filter membranes. In some embodiments, the dielectric layer 220 and the electrolyte sheath 230 are penetrable to metal ions (e.g. Nickel ions) but are not porous to electrons. Accordingly, metal ions may freely pass through the electrolyte sheet, while electrons may not pass through the electrolyte sheet. Additionally, the electrolyte sheet 230 and/or dielectric layer 220 may prevent shorting of the of wire anode against an inner wall of a metal conduit being coated.

In some embodiments, the electrochemical plating process may produce particles, such as stray metal particulate, at the auxiliary electrode 210. The dialectic layer 220 and electrolytic sheath 330 further prevent any metal particulate from exiting the encased auxiliary electrode 210 and prevent contamination of the plating solution. This also prevents metal particulate from facilitating the degradation of any components of the electrochemical plating apparatus.

FIG. 3A illustrates a cross-sectional view of a coated metal conduit 310 according to aspects of the present disclosure. In embodiments, 300a depicts a metal conduit 310 with a metal coating 320. In some embodiments, the metal conduit 310 may include a bulk metal or a metal alloy (e.g. aluminum, stainless-steel, etc.). In one embodiment, the metal conduit 310 includes stainless steel.

In some embodiments, a metal coating 320 includes one or more layers of Nickel metal. In some embodiments, the one or more layers of the metal coating 320 include an electroplatable metal (e.g. copper, silver, gold, Nickel, etc.). In some embodiments, the one or more layers of metal coating 320 are Nickel metal.

In some embodiments, the one or more layers of metal of the metal coating 320 are a strike and are deposited on the internal surface of the metal conduit 310 using a strike process such as the Wood's Nickel strike process. In some embodiments, the one or more layers of the metal coating 320 have a combined thickness of about 1 micron to about 5 microns. In other embodiments, the one or more layers of the metal coating 320 have a combined thickness of about 2 micron to about 4 microns. In other embodiments, the one or more layers of the metal coating 320 have a combined thickness of about 3 micron to about 5 microns. In other embodiments, the one or more layers of the metal coating 320 have a combined thickness of less than 1 micron.

FIG. 3B, illustrates a cross-sectional view of a coated metal 310 conduit according to aspects of the present disclosure.

In embodiments, 300b depicts a metal conduit 310 with a metal coating 320 and additional metal layers 330 deposited onto the metal coating 320. The deposition of the additional metal layers 330 may be performed by an electroless plating process. In some embodiments, the additional metal layers 330 may include an electro-plateable element (e.g. copper, silver, gold, Nickel, lead etc.). In some embodiments, the additional metal layers 330 include Nickel metal. In some embodiments, the additional metal layers 330 are of a same metal as metal layer(s) 320. In some embodiments, the additional metal layers 330 are of a different metal as metal layer(s) 320.

In some embodiments, the additional metal layers 330 are deposited using a corresponding metal phosphate of the metal layers (330 or 320). In other embodiments, plating solution may include a metal salt of the corresponding metal layer.

In some embodiments, the additional metal layers 330 have a combined thickness of about 5 micron to about 200 microns. In other embodiments, the additional metal layers 330 have a combined thickness of about 10 microns to about 190 microns. In other embodiments, the additional metal layers 330 have a combined thickness of about 20 microns to about 180 microns. In other embodiments, the additional metal layers 330 have a combined thickness of about 30 microns to about 170 microns. In other embodiments, the additional metal layers 330 have a combined thickness of about 40 microns to about 160 microns. In other embodiments, the additional metal layers 330 have a combined thickness of about 50 microns to about 150 microns. In other embodiments, the additional metal layers 330 have a combined thickness of about 60 microns to about 140 microns. In other embodiments, the additional metal layers 330 have a combined thickness of about 70 microns to about 130 microns. In other embodiments, the additional metal layers 330 have a combined thickness of about 80 microns to about 120 microns. In other embodiments, the additional metal layers 330 have a combined thickness of about 90 microns to about 110 microns. In other embodiments, the additional metal layers 330 have a combined thickness of about 100 microns to about 105 microns. In other embodiments, the additional metal layers 330 have a combined thickness of about 5 microns to about 100 microns. In other embodiments, the one or more layers of the metal coating 330 have a combined thickness of greater than 200 microns.

The boundary between the additional metal layers 330 and the underlying metal layers 320 and/or between the metal layers 320 and the metal conduit 310 deposited thereon may be discrete or not-discrete (e.g., the additional metal layers 330 and metal layers 320 and/or the metal conduit 310 and the metal layer 320 may be intermixed/interdiffused/integral).

In some embodiments, the additional metal layers 330 may be formed on the article 310 to improve the performance of the article 310 in high temperature applications (e.g., at temperatures higher than those applied for sputtering resistance). For example, nickel has mechanical properties, that is, physical properties exhibited upon application force (e.g., modulus of elasticity, tensile strength, elongation, hardness, fatigue limit, etc.), that exceeds other metals (e.g., aluminum, other metals and alloys used in low temperature applications). Additional metal layers 330 may be used in applications with temperatures up to about 800° C. for bulk metal conduits.

In embodiments, the term anode or anode wire are used to refer to the combination of the auxiliary electrode and any coating of the auxiliary electrode (e.g. dielectric layer, polymeric electrolyte sheath, etc.).

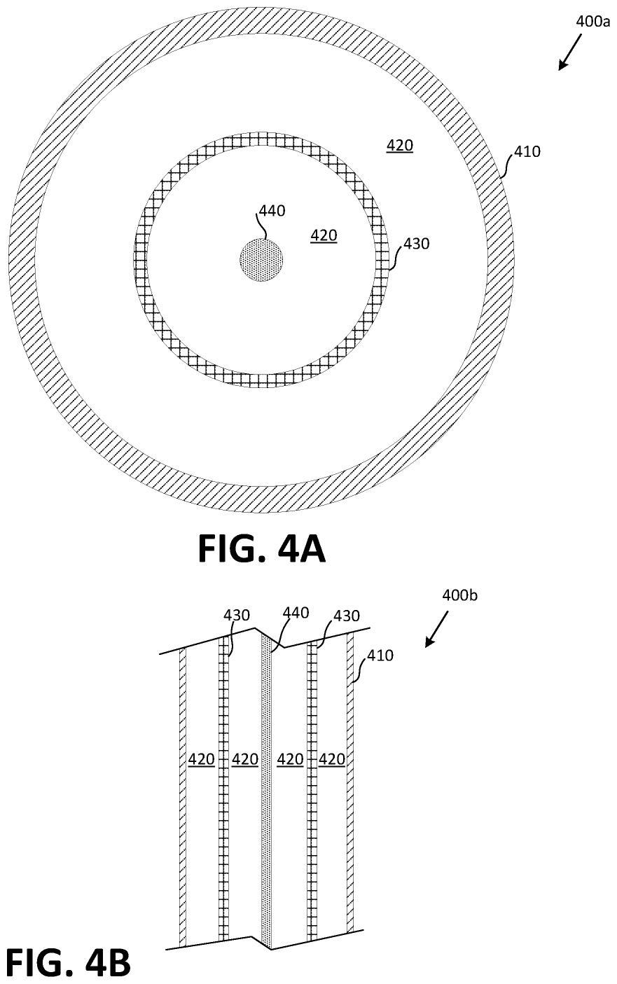

FIG. 4A illustrates a cross-sectional view 400a of an auxiliary electrode 440 threaded through a metal conduit 410 with plating solution 420 occupying volume between the auxiliary electrode 440, the electrolytic sheath 430, and the metal conduit 420, according to aspects of the present disclosure.

In some embodiments, the electrolytic sheath 430 is laminated to the auxiliary electrode 440. In some embodiments, the electrolytic sheath 430 is unattached to the auxiliary electrode 440. In some embodiments, the electrolytic sheath 430 is tethered to the auxiliary electrode 440 (not pictured). In some embodiments, the space between the auxiliary electrode 440 and the electrolytic sheath may be occupied by Nickel strike electrolyte 420. In some embodiments, the space between the auxiliary electrode and the electrolytic sheath may be occupied by a metal electrolyte 420 for Woods strike deposition.

In some embodiments, the space between the electrolytic sheath 430 and the metal conduit 410 be occupied by Nickel strike electrolyte 420. In some embodiments, the space between the metal conduit 410 and the electrolytic sheath 430 may be occupied by a metal electrolyte 420 for Woods strike deposition.

In some embodiments, the metal conduit 410 may be coupled to the auxiliary electrode 440 via a power supply (not pictured) and may be in a complete circuit.

FIG. 4B illustrates a schematic sectional view 400b of an anode 440 threaded through a metal conduit 410 with plating solution 420 occupying volume between the anode 440, the electrolytic sheath 430, and the metal conduit 420, according to aspects of the present disclosure.

In some embodiments, the electrolytic sheath 430 is laminated to the auxiliary electrode 440. In some embodiments, the electrolytic sheath 430 is unattached to the auxiliary electrode 440. In some embodiments, the electrolytic sheath 430 is tethered to the auxiliary electrode 440 (not pictured). In some embodiments, the space between the auxiliary electrode 440 and the electrolytic sheath may be occupied by Nickel strike electrolyte 420. In some embodiments, the space between the auxiliary electrode and the electrolytic sheath may be occupied by a metal electrolyte 420 for Woods strike deposition.

In some embodiments, the space between the electrolytic sheath 430 and the metal conduit 410 be occupied by Nickel strike electrolyte 420. In some embodiments, the space between the metal conduit 410 and the electrolytic sheath 430 may be occupied by a metal electrolyte 420 for Woods strike deposition.

In some embodiments, the metal conduit 410 may be coupled to the auxiliary electrode 440 via a power supply (not pictured) and may be in a complete circuit.

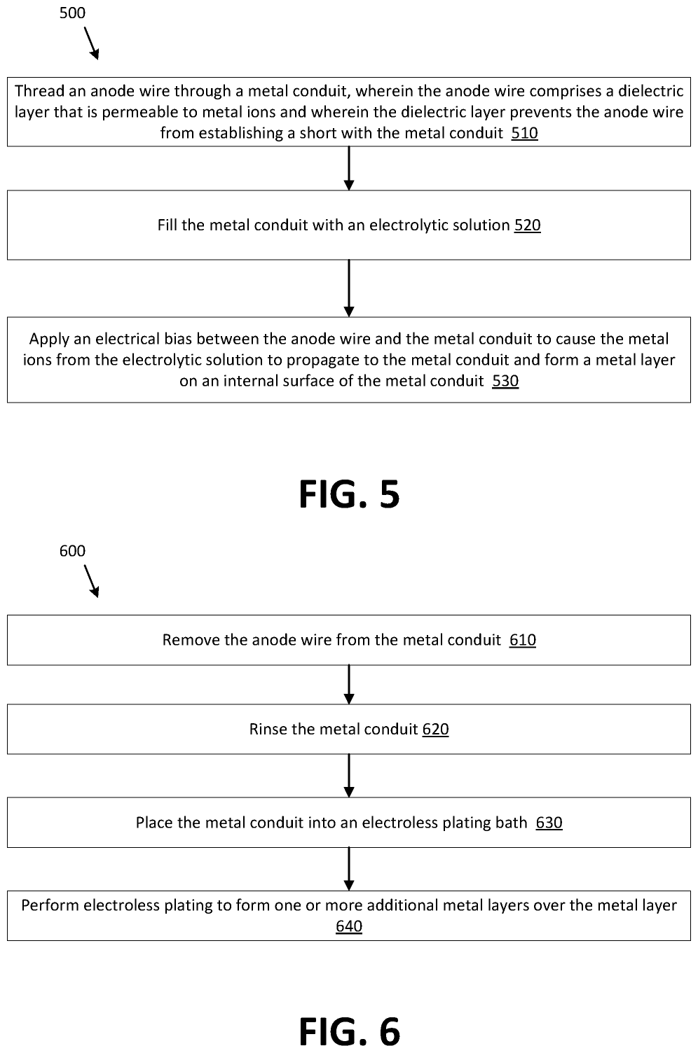

FIG. 5 is a flow chart 500 for a method of depositing a metal layer on the internal surface of a metal conduit, according to embodiments of the present disclosure. At block 510, an anode wire is threaded through a metal conduit. In some embodiments, the anode wire includes a dielectric layer that is permeable to metal ions. In some embodiments, the dielectric layer prevents the anode wire from establishing a short with the metal conduit. At block 520, the metal conduit is filled with an electrolytic solution. At block 530, an electrical bias is applied between the anode wire and the metal conduit to cause the metal ions from the electrolytic solution to propagate to the metal conduit and form a metal layer on an internal surface of the metal conduit.

In embodiments, the process for coating a conduit, prior to forming the additional metal layer coating, may be an electrolytic plating wet chemistry process performed with equipment capable of monitoring, controlling and recording all parameters that affect product quality. Such parameters include, but are not limited to, processing time, temperature, compositions of chemistry, concentration of the chemistry, voltages and current densities, method of rinsing, resistivity of rinsing water and operations of ultrasonic equipment, frequency of ultrasonic tool, etc.

In some embodiments, pre-cleaning may be applied to the incoming part prior to the electrolytic plating process to enable the highest coating quality. Chemical baths may be monitored regularly for adequate control of chemical composition, concentration, pH value, and level of metallic impurities. All chemical baths may be filtered and shall be free of any visible surface films or scums. Tanks may be covered when not in use. Chemical baths and DI water in immersion tanks may be agitated by oil-free clean dry air or nitrogen. Mechanical agitation may be configured to prevent contamination by particles or hydrocarbons. DI water may be used for various stages of rinsing using: a) rinse by spray or immersion is acceptable by using cold DI water with specific resistivity of no less than 200 K Ohm-cm; b) by power spray blind holes, creases, and non-welded seams by using cold DI water with specific resistivity of no less than 2 M Ohm-cm; or c) hot rinse by immersion in a hot DI bath of 38 to 46° C. (100 to 115° F.) with minimum resistivity of 4 M Ohm-cm. DI water in immersion tanks may be overflowing.

FIG. 6 is a flow chart 600 for a method of performing electroless plating on the metal layers of the internal surface of a metal conduit, according to embodiments of the present disclosure. At block 610, the anode wire is removed from the metal conduit. At block 620, the metal conduit is rinsed. At block 630, the metal conduit is placed into an electroless plating bath. At block 640, electroless plating is performed to form one or more additional metal layers over the metal layer.

In embodiments, depositing the metal layer at block 640 may be by an electroless metal plating process or an electrolytic metal plating process as described herein. The metal conduit may be coated with, for example, an electroless metal plated coating layer following a process for the electrolytic deposition of a coating (e.g., a nickel-phosphorous coating) on metallic components used in corrosive environments that contain corrosive chemicals. The electroless metal plating process can form a coating directly on a bulk metal-containing conduit or on an intermediate layer formed on the surface of the conduit. The electroless metal plating process does not rely on electric current, so the electroless metal plated coating can be deposited on any suitable surface including an insulator surface.

In some embodiments, the electroless metal plating process may take place at an elevated temperature. In some embodiments, the process may take place at a temperature of about 20 degrees C. to about 100 degrees C. In other embodiments, the process may take place at a temperature of about 30 degrees C. to about 100 degrees C. In other embodiments, the process may take place at a temperature of about 40 degrees C. to about 100 degrees C. In other embodiments, the process may take place at a temperature of about 50 degrees C. to about 100 degrees C. In other embodiments, the process may take place at a temperature of about 60 degrees C. to about 100 degrees C. In other embodiments, the process may take place at a temperature of about 70 degrees C. to about 100 degrees C. In other embodiments, the process may take place at a temperature of about 80 degrees C. to about 100 degrees C. In other embodiments, the process may take place at a temperature of about 80 degrees C.

In some embodiments, rinsing between metal coatings may be applied to the incoming part prior to the electrolytic plating process to enable the highest coating quality. Chemical baths may be monitored regularly for adequate control of chemical composition, concentration, pH value, and level of metallic impurities. All chemical baths may be filtered and shall be free of any visible surface films or scums. Tanks may be covered when not in use. Chemical baths and DI water in immersion tanks may be agitated by oil-free clean dry air or nitrogen. Mechanical agitation may be configured to prevent contamination by particles or hydrocarbons. DI water may be used for various stages of rinsing using: a) rinse by spray or immersion is acceptable by using cold DI water with specific resistivity of no less than 200 K Ohm-cm; b) by power spray blind holes, creases, and non-welded seams by using cold DI water with specific resistivity of no less than 2 M Ohm-cm; or c) hot rinse by immersion in a hot DI bath of 38 to 46° C. (100 to 115° F.) with minimum resistivity of 4 M Ohm-cm. DI water in immersion tanks may be overflowing.

In some embodiments, additional finishes or treatments may be applied to the additional metal layers prior to use.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within +10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
threading an anode wire through a metal conduit, wherein the anode wire comprises a dielectric layer that is permeable to metal ions, and wherein the dielectric layer prevents the anode wire from establishing a short with the metal conduit;
filling the metal conduit with an electrolytic solution; and
applying an electrical bias between the anode wire and the metal conduit to cause the metal ions from the electrolytic solution to propagate to the metal conduit and form a metal layer on an internal surface of the metal conduit.

2. The method of claim 1, wherein the dielectric layer comprises a polymeric electrolyte sheath.

3. The method of claim 1, wherein the metal conduit comprises a gasline pipe.

4. The method of claim 1, wherein the metal layer has a thickness of about 1 micron to about 5 microns.

5. The method of claim 1, further comprising:
removing the anode wire from the metal conduit;
placing the metal conduit into an electroless plating bath; and
performing electroless plating to form one or more additional metal layers over the metal layer.

6. The method of claim 5, further comprising:
rinsing the metal conduit after removing the anode wire and before placing the metal conduit in the electroless plating bath.

7. The method of claim 5, wherein a combined thickness of the metal layer and the one or more additional metal layers is about 5 microns to about 100 microns.

8. The method of claim 5, wherein the electroless plating is performed at a temperature of about 70 degrees C. to about 100 degrees C.

9. The method of claim 5, wherein the metal layer is a Nickel strike, and wherein the one or more additional metal layers comprise Nickel layers.

10. The method of claim 1, wherein the metal layer comprises a Nickel layer.

11. The method of claim 1, wherein the metal conduit comprises a curved portion.

12. The method of claim 1, wherein the dielectric layer comprises a porous coating.

13. The method of claim 1, wherein filling the metal conduit with the electrolytic solution comprises pumping the electrolytic solution at least one of into or through the metal conduit.

14. The method of claim 1, wherein filling the metal conduit with the electrolytic solution comprises disposing the metal conduit in a fluid basin at least partially filled with the electrolytic solution.

15. An apparatus comprising:
a fluid basin configured to retain an electrolytic solution to be used to coat an interior surface of a metal conduit with a metal layer;
an anode wire to be threaded through the metal conduit, wherein the anode wire comprises a dielectric layer that is permeable to metal ions, and wherein the dielectric layer prevents the anode wire from establishing a short with the metal conduit; and
an electrical source to apply an electrical bias between the anode wire and the metal conduit while the electrolytic solution is within the metal conduit to cause the metal ions from the electrolytic solution to propagate to the metal conduit and form the metal layer on the internal surface of the metal conduit.

16. The apparatus of claim 15, wherein the dielectric layer comprises a polymeric electrolyte sheath.

17. The apparatus of claim 16, wherein the polymeric electrolyte sheath comprises an ion exchange material based on a fluorinated polymer matrix.

18. The apparatus of claim 16, wherein the fluid basin is configured to receive the metal conduit such that the metal conduit is immersed in the electrolytic solution in the fluid basin.

19. The apparatus of claim 16, further comprising:
a fluid delivery system comprising a pump that is to pump the electrolytic solution from the fluid basin at least one of into or through the metal conduit.

20. The apparatus of claim 16, wherein the metal layer comprises a Nickel plating.
